(19) United States
(12) Patent Application Publication
(10) Pub. No.: US 2018/0027996 A1
(43) Pub. Date: Feb. 1, 2018

(54) ARTICLE HANGER

(71) Applicant: LOREN OLEPI BRANDENBURG, STAFFORD SPRINGS, CT (US)

(72) Inventor: LOREN OLEPI BRANDENBURG, STAFFORD SPRINGS, CT (US)

(21) Appl. No.: 15/223,096

(22) Filed: Jul. 29, 2016

(51) Int. Cl. A47G 1/16; F16M 13/02; A47G 1/17

(52) U.S. Cl. CPC A47G 1/1633; A47G 1/17; F16M 13/02

(57) ABSTRACT

An article hanger (or holder) that is suitable for mounting to a vertical surface and securely holding an article thereto is disclosed. Also disclosed is a means for covering the fasteners used for mounting the article holder and in some embodiments, the article holder is suitable for mounting outside the periphery of the article such that the hanger is visible after attachment of the article to the hanger. The article hanger includes features that secure the hanging cord of an article thereby preventing relative movement between the article and the hanger and the deleterious effects caused thereby.

### BACKGROUND OF THE INVENTION

### Field of the Invention

Embodiments of the invention generally relate to an article hanging apparatus for hanging articles such as pictures, framed art and other wall art and more particularly to such an apparatus that includes a channel and a fastener cover.

### Description of the Related Art

Articles such as pictures, framed art, paintings, plaques and the like are often hung on walls and other vertical surfaces. There exists in the prior art a plethora of devices and methods for achieving this objective including a bare nail or fastener protruding from a vertical surface.

A typical article hanger of the prior art includes a picture hook. The typical picture hook is a device that mounts to a wall with a fastener, often a nail or screw, that extends through a hole the device and engages with the wall material or a device adapted to engage with the wall material. Such a picture hook often includes a hook portion that engages with a wire, cable, twine or other such mounting cord type connection that extends across the back of the picture. The typical picture hook is utilitarian in appearance and is therefore typically mounted to the wall within the limits of the article and hidden from view thereby. This behind-the-article mounting makes it difficult to observe the insertion of wire into the hook and can be extremely difficult if the picture is large and/or heavy. In addition to the aforementioned limitations of the typical article hanger of the prior art, the surface area of the hook is typically inadequate to provide enough purchase with the mounting wire to prevent slippage over time due to vibrations and the like. When the article slips relative to the hook, it becomes skewed on the wall and has to be readjusted.

Another type of article hanger is disclosed in US20110121142, which comprises a nail, or other fastener integrated within an “auxiliary head”. The article hanger disclosed therein is fastened to the wall by applying force to the auxiliary head, with a hammer, for example. Other article hangers with integrated fasteners exist in the prior art. One feature of such an article hanger is that it can be mounted to the wall outside of the periphery of the article, the article is hung from the hanger with wire, cable, twine or other such cord type connection extending from the article, and it lends a decorative aspect to the hanger and article combination. One problem with such prior art devices is that the user cannot change the type of fastener which may or may not be of suitable design for the article or the wall material or a device adapted to engage with the wall material. Another problem is that force is applied directly to the article hanger itself in order to engage with the wall or vertical surface leading to potential damage of the article hanger. Still another problem associated with the prior art is that it is difficult to remove the article hanger without damaging it, making reuse challenging.

Therefore, there exists a need for a reusable article hanger that can securely attach an article to a vertical surface and provide a functional aesthetic aspect.

### SUMMARY OF THE INVENTION

In accordance with some aspects of the present disclosure, systems and methods related to a novel article hanger are disclosed.

In some aspects of the present invention, the article hanger includes a body having a grooved portion protruding therefrom and a cover releasably mounted on the body to cover mounting holes positioned in the body.

In other aspects of the present invention, the groove of the article hanger is formed by a lip portion that forms an inner groove for receiving a cord attached to an article.

In still other aspects of the present invention, the cover is releasably mounted to the body by a plug and hub in an interference snap fit arrangement.

In yet other aspects of the present invention a method of hanging an article on a vertical surface includes mounting an article hanger which includes a groove on the vertical surface with a fastener and positioning a cover over the fastener and positioning a cord attached to the article within the groove.

### BRIEF DESCRIPTION OF THE DRAWINGS

So that the manner in which the above-recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is an isometric view of an embodiment of an article hanger in accordance with the present disclosure;

FIG. 2 is a front view of an article hanger in accordance with certain aspects the present disclosure;

FIG. 3 is a front view of the body of an article hanger in accordance with certain aspects the present disclosure;

FIG. 4 is a rear view of the body of an article hanger in accordance with certain aspects the present disclosure;

FIG. 5 is a rear view of the cover of an article hanger in accordance with certain aspects the present disclosure; and

FIG. 6 is an illustration of an article hanger in accordance with certain aspects the present disclosure.

### DETAILED DESCRIPTION

The present invention is an article hanger (or holder) that is suitable for mounting to a vertical surface and securely holding an article thereto. The present invention includes a means for covering the fasteners and in some embodiments is suitable for mounting outside the periphery of the article such that the hanger of the present invention is visible after attachment of the article to the hanger.

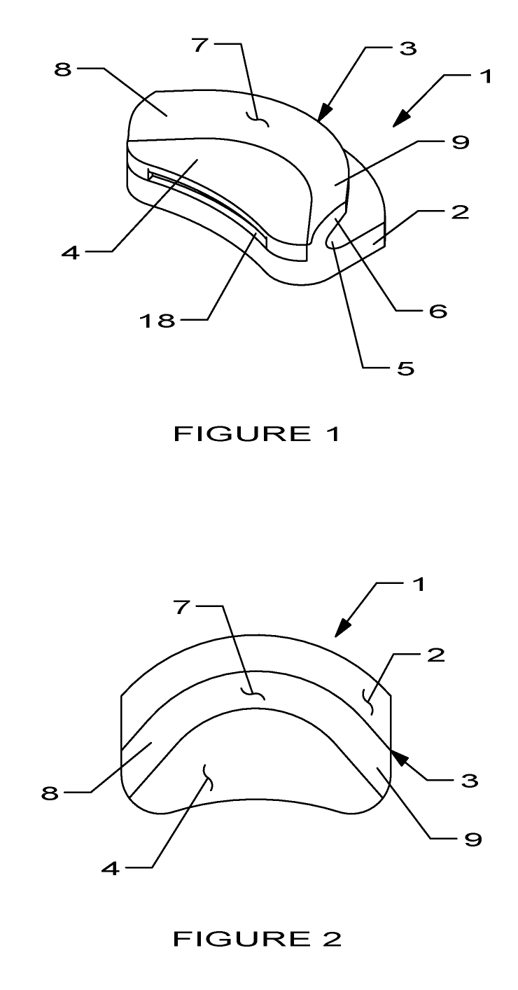

Referring to FIGS. 1 and 2, there is illustrated an article holder 1 in accordance with certain embodiments of the present invention. As will be more fully explained herein below, article holder 1 includes a body portion 2, an arcuate groove portion 3, and a cover 4. It should be appreciated by those skilled in the art that the dimensions of article hanger 1 may vary to accommodate articles of various sizes and weights without departing from the scope of the present invention.

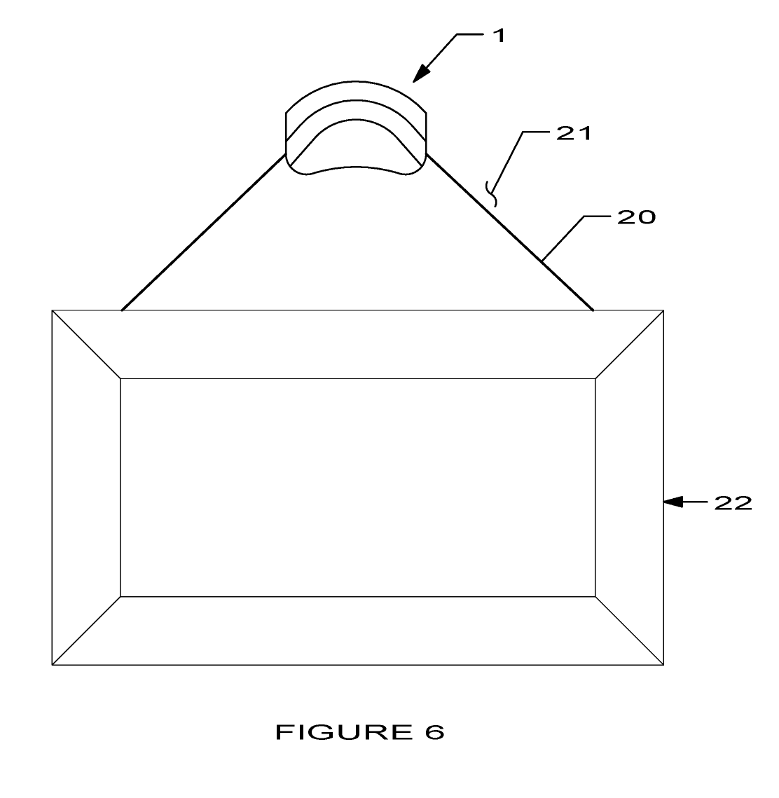

Still referring to FIGS. 1 and 2, arcuate groove 3 is curvilinear and includes an inner groove 5 that is formed in body 2 by upturned lip 6 protruding therefrom. Inner groove 5 and outer lip 6 cooperate to engage a mounting cord (20 in FIG. 6) connected to an article to support the article when the article hanger is mounted to a wall or vertical surface as will be more fully described hereinafter. In the embodiment shown in the figures arcuate groove 3 has a curved portion 7 terminating in straight sections 8 and 9. In the embodiment shown, inner groove 5 has an inner most radius of about 0.15 inches and lip 6 has an outer most radius of about 0.95 inches in curved portion 7.

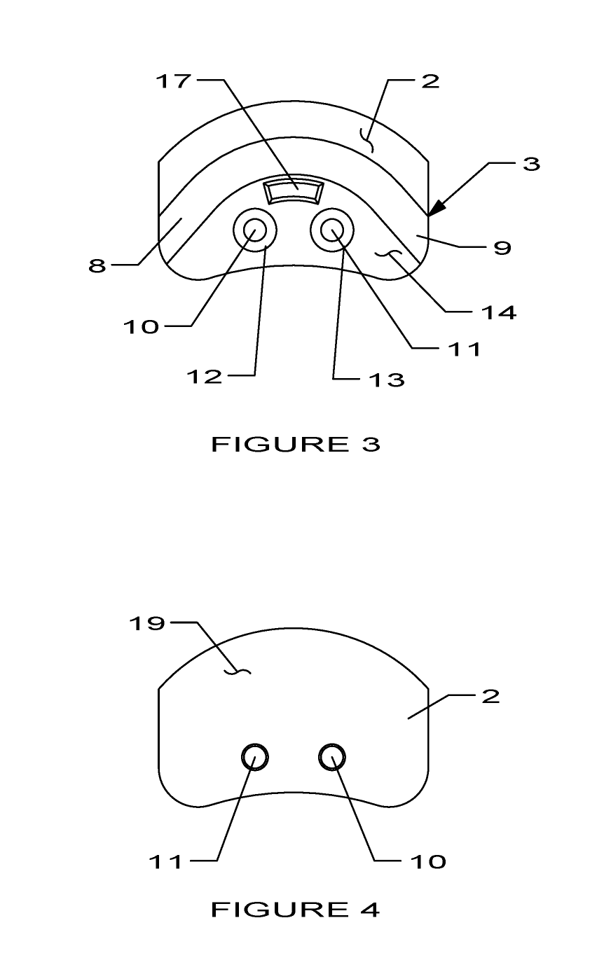

The mounting features of the present invention are best described with reference to FIGS. 3 and 4 wherein mounting holes 10, 11 are shown formed in body 2. Although two holes are shown, more or fewer holes may be included in body 2 without departing from scope of the present invention. It should be appreciated by those skilled in the art that the type and size of hole is chosen to accommodate the type and size of fastener of choice as well as the weight of the article to be supported. In the embodiment shown holes 10, 11 are sized to accommodate a #8 screw (not shown) and advantageously include counterbores 12, 13 to accept the head of the screw. In such an embodiment the heads of the screw do not protrude above the mounting surface 14 of body 2 allowing the installation of cover 4 as will be more fully described hereinafter.

Referring now to FIG. 4, back surface 19 of body 2 advantageous includes at least a partial planar portion to adapt to a wall (21 in FIG. 6). It should be appreciated that surface 19 may comprise any finish (smooth or otherwise) or material (such as glue, Velcro or tape) that is contemplated to aid in positioning article hanger 1 on a vertical surface before inserting fasteners as will be more fully described hereinafter.

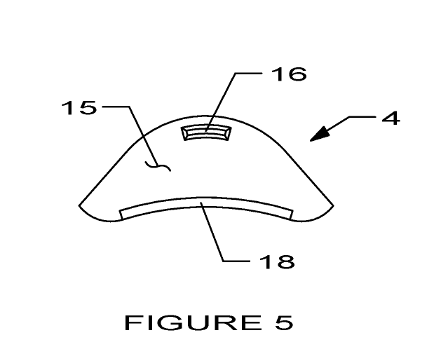

With reference to FIG. 5 and FIGS. 1 and 3, the present invention advantageously includes a removable cover 4 that, when installed in body 2, conceals the fasteners (not shown) that are installed in mounting holes 10, 11 from view. Cover 4 may be removably installed onto mounting surface 14 of body 2 using any known method such as a releasable joint, snap fit, hook and loop fastener (such as Velcro®), magnetic attraction, adhesive, tape, etc. In the particular embodiment shown in the figures, cover 4 is releasable affixed to surface 14 of body 2 using a perimeter snap joint. The snap joint is basically comprised of features in the cover 4 and body 2 that fit together in an interference fit. Referring to FIG. 5, depicting a back surface 15 of cover 4, the cover includes a male plug 16 protruding from the surface. Now referring to FIG. 3, body 2 includes a female hub 17 formed within mounting surface 14 of body 2. Plug 16 and hub 17 are positioned and sized to mate with one another. The outside dimension of plug 16 is slightly larger than the inside dimensions of its mating hub 17 and when mated together the plug and hub deflect to form an interference snap fit and removabley positions the cover over mounting surface 14. It should be appreciated by those skilled in the art that plug 16 may include a ridge and hub 17 may include a corresponding groove such that, when the plug and hub are mated, the ridge is positioned within the groove to perform a snap fit that is in a stress-free condition. In the embodiment shown in FIGS. 1 and 5, cover 4 further includes a removal slot 18 positioned within cover 4 and extending into surface 15. Slot 18 provides a means to insert a small tool, or fingernail, between cover 4 and mounting surface 14 to prise the cover off the body 2 in order to access the fasteners. In alternative embodiments, the slot may be positioned within body 2 and projecting into mounting surface 14.

It should be appreciated by those skilled in the art that the article holder 1 of the present invention may be comprised of a variety of materials and formed using a myriad of techniques. For instance, article hanger 1 may be comprised of a metal, a plastic, a structural foam or any combinations thereof. Metals may include steels, aluminum, brass and others including various alloys. Plastics may include any known polymers (including ABS, nylon, polyethylene, polypropylene, PVC, PEEK, thermoplastics, thermosets and engineered composite materials and wood filament). Article hanger 1 may be formed using removal manufacturing such as machining, molding, or additive manufacturing such as 3-D printing. Machining processes may include any known processes including milling, drilling, abrasion, acid etching and the like. Molding processes may include injection, blow, compression, film insert, gas assist, rotational, and thermoforming and the like.

Although referred to herein above generically as a cord, and with reference to FIGS. 1, 2 and 6, cord 20 may comprise any of a wire, cable, twine, rope or other such suitable means of attachment of article 22. It should be understood that in addition to having sufficient tensile strength to support the weight of article 22, cord 20 should be selected from a type of material that is flexible enough to lay within arcuate groove 3 and engage with inner groove 5. It is a further advantage if, taking the material type of body 2 into account, cord 20 is selected from a type of material that provides sufficient frictional force against inner groove 5 to resist relative motion between the cord and the groove due to vibrations and other movements of surface 21. When cord 20 is properly selected by a user, and installed within arcuate groove 3 as described herein below, cord 20 wraps around, and is supported by, the curved section 7 and lays within the straight sections 8, 9 of inner groove 5. It is this relatively high surface area between inner groove 5 and cord 20, as compared to the prior art, that provides for the resistance of relative motion between the cord and the article hanger 1. The curvature of inner groove 5 and surface smoothness (and features such as protrusions) may also be adapted to provide a higher degree of engagement between article hanger 1 and cord 20 to resist relative motion without departing from the scope of the present invention.

### Example Methods of Employing an Article Hanger of the Present Invention

An exemplary method of employing the article hanger 1 of the present invention is best described with reference to the embodiments shown in the various figures. With reference to FIGS. 3 and 6, a user positions body 2 of article hanger 1 in a preselected location on a vertical surface 21 using any known technique. The user then chooses an appropriate fastener such as a nail or a screw (not shown). If the article hanger is to be mounted to a hard surface such as brick or mortar, an expansion type anchor(s) may first be installed in the surface. If the article hanger is to be mounted to a hollow or low-density material such as drywall or hollow core doors, a threaded type anchor or a toggle type anchor may first be installed into the surface. It should be appreciated by those skilled in the art that the scope of the present invention includes the use of fastener types to accommodate a plethora of known devices adapted to engage with the wall material.

With body 2 of article hanger 1 appropriately fastened to surface 21 as described immediately herein above, a user positions cover 4 on top of mounting surface 14 and engages plug 16 into hub 17 in a removable snap engagement. With cover 4 thus installed, the fasteners (not shown) and holes 10, 11 are no longer visible as is best shown with reference to FIG. 6.

Still referring to FIG. 6, there is shown an article 22 including a cord 20 affixed thereto employing any known method. A user positions article 22 in a position approximate to a preselected position below article hanger 1 and deposits cord 20 within arcuate groove 7. The user then positions article 22 in a final desired position by leveling (if desired) the article and sliding cord 20 within arcuate groove 7. Once the final desired position is achieved, article 22 is safely and sufficiently supported by article hanger 22.

Although shown mounted outside the periphery of article 22, it is within the scope of the present invention that article hanger 1 is suitable for mounting behind the article. In addition to the other advantages articulated herein above, when mounted behind the article, the present invention has the advantage over certain of the prior art of making it easier to apply the cord to the arcuate groove of the article hanger and provides for a more stable mounting technique.

The present invention provides for the easy removal of article hanger 1 if, after installation as described directly above, the user chooses to move, or remove, the article from the first desired position. Cover 4 is removed by using a fingernail or suitable tool, such as a screwdriver or other such lever, inserted into the gap between cover 4 and mounting surface 14 formed by slot 18 positioned in cover 4. The cover can then be pried off, disengaging the snap connection between plug 16 and hub 17. With cover 4 thus removed, the fasteners are exposed and can be removed using any known technique appropriate for the fastener type. The article hanger can then be disengaged from the wall 21 and reinstalled in a second desired position in accordance with the methods described hereinabove.

While the foregoing is directed to embodiments of the present invention, other and further embodiments of the invention may be devised without departing from the basic scope thereof, and the scope thereof is determined by the claims that follow.

1. An article hanger comprising:
a body having a front side and a mounting surface positioned thereon;
a groove protruding from the front side of the body wherein the groove includes a curved portion positioned between a pair of straight sections;
at least one mounting hole formed in the body and projecting through the surface portion; and
a cover adapted to releasably mount to the mounting surface.

2. The article hanger of claim 1 wherein the groove further comprises a lip that protrudes from the body and forms an inner groove and an outer lip portion.

3. The article hanger of claim 2 wherein the groove further comprises at least a partial arcuate shape.

4. (canceled)

5. The article hanger of claim 1 wherein the cover is releasably mounted to the mounting surface by a releasable joint, a magnetic force, adhesive, tape or a hook and loop fastener.

6. The article hanger of claim 5 wherein the cover includes a male plug and wherein the mounting surface includes a female hub and the male plug and female hub are adapted to engage in an interference fit with one another.

7. The article hanger of claim 1 wherein the cover further includes a slot positioned in back side of the cover and projects partially through the cover.

8. The article hanger of claim 1 wherein the groove is adapted to receive a mounting cord attached to an article for securely hanging an article therefrom.

9. The article hanger of claim 1 wherein the article hanger is adapted to mount to a vertical surface.

10. A method of hanging an article on a vertical surface comprising:
attaching a mounting cord on an article;
mounting an article hanger on the vertical surface with a fastener, wherein the article hanger comprises:
a body having a front side and a mounting surface positioned thereon;
a groove protruding from the front side of the body wherein the groove includes a curved portion positioned between a pair of straight sections;
at least one mounting hole formed in the body and projecting through the surface portion; and
a cover adapted to releasably mount to the mounting surface;
installing the cover on the mounting surface and over the fastener; and
positioning the cord within the groove such that the cord wraps around the curved portion and lays within the straight sections resisting relative motion between the cord and article hanger.

11. The method of claim 10 wherein the groove includes a plurality of protrusions positioned therein.

12. The article hanger of claim 1 wherein the groove includes a plurality of protrusions positioned therein.
